(19) United States
(12) Patent Application Publication
(10) Pub. No.: US 2018/0180357 A1
(43) Pub. Date: Jun. 28, 2018

(54) PROCESS FOR PRODUCING ONE OR MORE AIR PRODUCTS, AND AIR SEPARATION PLANT

(71) Applicant: Dimitri Golubev, Geretsried (DE)

(72) Inventor: Dimitri Golubev, Geretsried (DE)

(21) Appl. No.: 15/847,990

(22) Filed: Dec. 20, 2017

(30) Foreign Application Priority Data
Dec. 28, 2016 (EP) 16 020 517.5

(51) Int. Cl. F25J 3/04

(52) U.S. Cl. CPC F25J 3/04084; F25J 3/04024; F25J 3/04296; F25J 3/04927; F25J 3/04133; F25J 3/04303; F25J 2245/50; F25J 3/04393; F25J 2245/58; F25J 2240/12; F17C 2223/033; F17C 2223/0161; F25J 2205/04; F25J 3/04315

(57) ABSTRACT

A process and air separation plant for producing one or more air products by cryogenic separation of air in an air separation plant wherein a first fraction and a second fraction of feed air quantity are post-compressed in a post-compressor from a first pressure level to a second pressure level at least 3 bar above the first pressure level, and are extracted from a post-compressor jointly at the second pressure level, impure nitrogen, the nitrogen content of which lies below an overhead product of a high-pressure column, is extracted from the high-pressure column at the first pressure level and is expanded using a second turboexpander which is mechanically coupled to a first booster, and a fluid enriched with argon is extracted from a low-pressure column, is depleted of argon and is recycled into the low-pressure column.

### CROSS REFERENCE TO RELATED APPLICATIONS

This application claims priority from European Patent Application EP 16 020 517.5, filed on Dec. 28, 2016.

### BACKGROUND OF THE INVENTION

The invention relates to a process for the cryogenic separation of air, and to an air separation plant for producing one or more air products by cryogenic separation of air in an air separation plant having a distillation column system which comprises a high-pressure column, which is operated at a first pressure level, and a low-pressure column, wherein
a feed air quantity is compressed in a main air compressor to the first pressure level, from which a first fraction and a second fraction are post-compressed in a post-compressor and a third fraction is compressed only to the first pressure level and is fed at the first pressure level into the high-pressure column,
the post-compressed first fraction of the feed air quantity is successively compressed further using a first booster and a second booster is subsequently cooled, expanded to the first pressure level and fed in at least partially liquefied form into the high-pressure column, and
the post-compressed second fraction of the feed air quantity is cooled and is subsequently expanded, using a first turboexpander which is mechanically coupled to the first or to the second booster, to the first pressure level and fed into the high-pressure column.

The production of air products in liquid or gaseous form by cryogenic separation of air in air separation plants is known and described for example in H.-W. Häring (Ed.), Industrial Gases Processing, Wiley-VCH, 2006, in particular section 2.2.5, “Cryogenic Rectification”.

Air separation plants have distillation column systems which can for example take the form of two-column systems, in particular conventional Linde two-column systems, but also three- or multi-column systems. In addition to the distillation columns for the production of nitrogen and/or oxygen in liquid and/or gaseous form, that is to say the distillation columns for nitrogen-oxygen separation, it is also possible to provide distillation columns for the production of other air components, in particular the noble gases krypton, xenon and/or argon.

The distillation columns of said distillation column systems are operated at different pressure levels. Known two-column systems have a so-called high-pressure column (also referred to as pressure column, medium-pressure column or lower column) and a so-called low-pressure column (also referred to as upper column). The pressure level of the high-pressure column is for example 4 to 6 bar, in particular approximately 5.3 bar. The low-pressure column is operated at a pressure level of for example 1.3 to 1.7 bar, in particular approximately 1.4 bar. In certain cases, for example for combined processes with integrated gasification (Integrated Gasification Combined Cycle, IGCC), pressures of 3 to 4 bar may also be used in the low-pressure column. The pressures stated here and below are absolute pressures at the top of the stated columns.

US 2005/126221 A1 has described an HAP process (see below), in which an additional compressor is used. U.S. Pat. No. 5,515,687 discloses an MAC-BAC process (likewise, see below), in which generator turbines are jointly used. Electrical energy generated by means of the generator turbines is used for driving the post-compressor. By contrast, drive of boosters by means of expansion turbines in an MAC-BAC process is known for example from US 2016/0231053 A1. A further arrangement with expansion turbines and boosters is known from FR 2 690 982 A1. U.S. Pat. No. 5,355,681 A discloses argon production.

It is the object of the present invention to make the cryogenic separation of air more energy-efficient and less expensive.

### SUMMARY OF THE INVENTION

Against this background, the present invention proposes a process for the cryogenic separation of air and an air separation plant.

In one embodiment, there is disclosed a process for producing one or more air products by cryogenic separation of air in an air separation plant having a distillation column system which comprises a high-pressure column, which is operated at a first pressure level, and a low-pressure column, wherein
a feed air quantity is compressed in a main air compressor to the first pressure level, from which a first fraction and a second fraction are post-compressed in a post-compressor and a third fraction is compressed only to the first pressure level and is fed at the first pressure level into the high-pressure column,
the post-compressed first fraction of the feed air quantity is successively compressed further using a first booster and a second booster is subsequently cooled, expanded to the first pressure level and fed in at least partially liquefied form into the high-pressure column, and
the post-compressed second fraction of the feed air quantity is cooled and is subsequently expanded, using a first turboexpander which is mechanically coupled to the first or to the second booster, to the first pressure level and fed into the high-pressure column, characterized in that
the first fraction and the second fraction of the feed air quantity are post-compressed in the post-compressor from the first pressure level to a second pressure level at least 3 bar above the first pressure level, and are extracted from the post-compressor jointly at the second pressure level,
impure nitrogen, the nitrogen content of which lies below the overhead product of the high-pressure column, is extracted from the high-pressure column at the first pressure level and is expanded using a second turboexpander, wherein
the second turboexpander is mechanically coupled to the booster taken from the group of the first and second boosters, which is not coupled to the first turboexpander, and
a fluid enriched with argon is extracted from the low-pressure column, is depleted of argon and is recycled into the low-pressure column.

In another embodiment, there is disclosed an air separation plant having a distillation column system which comprises a high-pressure column, which is designed for operation at a first pressure level, and a low-pressure column, wherein the air separation plant has:
a main air compressor which is designed for compressing a feed air quantity to the first pressure level, a post-compressor which is designed for post-compressing a first fraction and a second fraction of the feed air quantity, and means which are designed for compressing a third fraction of the feed air quantity only to the first pressure level and feeding said third fraction into the high-pressure column at the first pressure level,
a first booster and a second booster which are designed for successively further compressing the post-compressed first fraction of the feed air quantity, wherein means are provided which are designed for subsequently cooling the first fraction, expanding said first fraction to the first pressure level and feeding said first fraction in at least partially liquefied form into the high-pressure column, and
means which are designed for cooling the post-compressed second fraction of the feed air quantity, and a first turboexpander which is mechanically coupled to the first or to the second booster and which is designed for subsequently expanding the second fraction of the feed air quantity to the first pressure level and feeding said second fraction into the high-pressure column,
   characterized by means which are designed for
post-compressing the first fraction and the second fraction of the feed air quantity in the post-compressor from the first pressure level to a second pressure level at least 3 bar above the first pressure level, and extracting said first fraction and second fraction from the post-compressor jointly at the second pressure level,
extracting impure nitrogen, the nitrogen content of which lies below the overhead product of the high-pressure column, from the high-pressure column at the first pressure level and expanding said impure nitrogen using a second turboexpander, wherein
the second turboexpander is mechanically coupled to the booster taken from the group of the first and second boosters, which is not coupled to the first turboexpander, and
extracting a fluid enriched with argon from the low-pressure column, depleting said fluid of argon and recycling said fluid into the low-pressure column.

Embodiments are in each case subject matter of the dependent claims and of the description which follows.

Prior to explanation of the features and advantages of the present invention, some basic principles of the present invention will be discussed in more detail, and expressions used below will be defined.

The devices used in an air separation plant are described in the cited technical literature, for example in Häring in section 2.2.5.6, “Apparatus”. Where the following definitions do not deviate from this, reference is therefore explicitly made to the cited technical literature with regard to the linguistic usage in the context of the present application.

In the context of the present linguistic usage, liquids and gases can be rich or poor in one or more components, wherein “rich” may represent a content of not less than 50%, 75%, 90%, 95%, 99%, 99.5%, 99.9% or 99.99% and “poor” may represent a content of not more than 50%, 25%, 10%, 5%, 1%, 0.1% or 0.01% on a molar, weight or volume basis. The expression “predominantly” may correspond to the definition of “rich”. Liquids and gases may furthermore be enriched with or depleted of one or more components, wherein these expressions relate to a content in a starting liquid or a starting gas from which the liquid or the gas has been obtained. The liquid or the gas is “enriched” if said liquid or gas comprises a content of a corresponding component of at least 1.1 times, 1.5 times, 2 times, 5 times, 10 times, 100 times or 1000 times that of the starting liquid or the starting gas, and is “depleted” if said liquid or gas comprises a content of a corresponding component of at most 0.9 times, 0.5 times, 0.1 times, 0.01 times or 0.001 times that of the starting liquid or the starting gas. Here, where “oxygen” or “nitrogen” are referred to, for example, these are also to be understood to encompass a liquid or a gas which is rich in oxygen or nitrogen but which need not necessarily be composed exclusively thereof.

For characterization of pressures and temperatures, the present application uses the terms “pressure level” and “temperature level”, which is intended to express the fact that corresponding pressures and temperatures in a corresponding plant need not be used in the form of exact pressure and temperature values in order to implement the concept of the invention. However, such pressures and temperatures typically vary within particular ranges of, for example, ±1%, 5%, 10%, 20% or even 50% around a mean value. It is possible here for corresponding pressure levels and temperature levels to lie in disjoint ranges or in overlapping ranges. In particular, pressure levels for example include unavoidable or expected pressure losses. The same holds for temperature levels. The pressure levels stated here in bar are absolute pressures.

In air separation processes, for refrigeration and liquefaction at different locations, use may be made of turboexpanders such as are fundamentally known to a person skilled in the art. Below, “Claude turbines”, “Lachmann turbines” and “pressurized nitrogen turbines” are referred to. With regard to the function and purpose of such turboexpanders, reference is made to the technical literature, for example F. G. Kerry, Industrial Gas Handbook: Gas Separation and Purification, CRC Press, 2006, in particular sections 2.4, “Contemporary Liquefaction Cycles”, 2.6, “Theoretical Analysis of the Claude Cycle” and 3.8.1, “The Lachmann Principle”.

By means of a Claude turbine, in the case of a two-column system, cooled compressed air is expanded from a relatively high pressure level to the pressure level of the high-pressure column and is fed into the latter. By contrast, by means of a Lachmann turbine, cooled compressed air is expanded to the pressure level of the low-pressure column and is fed into the latter. By means of a pressurized nitrogen turbine, exclusively nitrogen from the high-pressure column is expanded. This expansion may be performed before said nitrogen has been fully heated in the main heat exchanger (so-called cold pressurized nitrogen turbine) or downstream thereof (so-called hot pressurized nitrogen turbine). The expanded nitrogen may subsequently be used in particular for the regeneration of adsorbers. Through the use of a pressurized nitrogen turbine, too, the energy consumption of an air separation plant can be lowered. If a pressurized nitrogen turbine is supplied with nitrogen from the top of the high-pressure column, said nitrogen is correspondingly pure. A pressurized nitrogen turbine may however also be supplied with impure nitrogen from the high-pressure column, such as is also the case in the context of the present invention. In the latter case, a corresponding pressurized nitrogen turbine is also referred to as “impure pressurized nitrogen turbine”. An impure pressurized nitrogen turbine is distinguished by the fact that a nitrogen-rich fluid is supplied thereto from the high-pressure column, the nitrogen content of which fluid lies below the nitrogen of the overhead product of the high-pressure column, that is to say below the maximum nitrogen content generatable in the high-pressure column. Said nitrogen-rich fluid is extracted from the high-pressure column in particular laterally, that is to say at least a few, that is to say at least 2, 3, 4 or 5, theoretical or practical plates below the top.

A turboexpander may be coupled by means of a common shaft to further expansion machines or energy converters such as oil brakes, generators or compressor stages. If one or more turboexpanders is or are coupled to one or more compressor stages (see below) and possibly additionally mechanically braked, such that the compressor stage(s) is or are operated without energy supplied externally, for example by means of an electric motor, the expression “booster turbine” is generally also used for this arrangement. The compressor stage(s) of a corresponding booster turbine is or are generally also referred to as “booster(s)”. Here, a booster turbine of said type compresses at least one stream by the expansion of at least one other stream, but without energy supplied externally, for example by means of an electric motor.

Here, by contrast, a compressor is to be understood to mean a device which is driven externally, typically electrically, and which is designed for compressing at least one gaseous stream from at least one inlet pressure, at which said gaseous stream is supplied to the compressor, to at least one final pressure, at which said gaseous stream is extracted from the compressor. Here, the compressor forms a structural unit, which may however have multiple individual compressor units or “compressor stages” in the form of known piston, screw and/or impeller or turbine arrangements (that is to say radial or axial compressor stages). In particular, said compressor stages are driven by means of a common drive, for example by means of a common shaft or a common electric motor. Multiple compressor stages can thus together form one or more compressors,

Rotating units, for example expansion machines or expansion turbines, compressors or compressor stages, booster turbines or boosters, rotors of electric motors and the like, may be mechanically coupled to one another, wherein, in the linguistic usage of this application, a “mechanical coupling” is understood to mean that a fixed or mechanically adjustable rotational speed relationship between such rotating units is producible by means of mechanical elements such as gearwheels, belts, transmissions and the like. A mechanical coupling may be produced generally by means of two or more in each case inter-engaging elements, which are for example in positively locking engagement or frictional engagement, for example gearwheels or drive pulleys with belts, or a rotationally conjoint connection. A mechanical coupling may be realized in particular by means of a common shaft on which the rotating units are in each case rotationally conjointly fastened. In this case, the rotational speed of the rotating units is equal.

The present invention is used in particular in conjunction with so-called MAC-BAC (“Main Air Compressor/Booster Air Compressor”) processes. An MAC-BAC process is distinguished by the fact that only a part of the total feed air quantity supplied to the distillation column system is compressed to a pressure level which lies significantly, that is to say at least 3, 4 or 5 bar, above the pressure level of the high-pressure column. A further part of the total feed air quantity supplied to the distillation column system is compressed only to the pressure level of the high-pressure column or to a pressure level typically not deviating by more than 1 to 2 bar therefrom, and is fed into the high-pressure column at said pressure level. That fraction of the total quantity of compressed air supplied to the distillation column system which is compressed to the relatively high pressure level may be expanded in an MAC-BAC process after partial cooling in a Claude turbine, as is also illustrated in the appended drawings.

In HAP processes, which are likewise used in air separation, it is by contrast the case that the entire feed air quantity supplied to the distillation column system is compressed to a pressure level which lies significantly, that is to say at least 3 bar, above the pressure level of the high-pressure column. The pressure difference amounts to at least 3 bar, though may also be considerably higher, for example 4, 5, 6, 7, 8, 9 or 10 bar and up to 14, 16, 18 or 20 bar. HAP processes are known for example from EP 2 980 514 A1 and EP 2 963 367 A1.

All of the nitrogen that is extracted from the high-pressure column and which is neither condensed and recycled as reflux into said high-pressure column nor condensed and used as liquid reflux into the low-pressure column fundamentally impairs the separation in the low-pressure column, because it is no longer available there as reflux. Such nitrogen is nitrogen extracted from the air separation plant in the form of a liquid or gaseous nitrogen product, and the nitrogen which, as discussed, is expanded in the pressurized nitrogen turbine and used in some other way. This also includes internally compressed nitrogen, that is to say liquid nitrogen which is extracted from the high-pressure column, pressurized in a pump and evaporated in the main heat exchanger. The internal compression is also discussed for example in Häring, section 2.2.5.2, “Internal Compression”.

Here, an “argon discharge” is understood generally to mean a measure in the case of which, from the low-pressure column, a fluid is extracted which is enriched with argon, that is to say which for example has an argon content of at least two times, five times or ten times, in relation to an oxygen-rich liquid fed in from the low-pressure column, in particular the bottoms product of the low-pressure column. An argon discharge furthermore comprises at least a part of the argon contained in a corresponding extracted fluid no longer being recycled into the low-pressure column. The fluid is in particular subjected to an argon depletion, and is only thereafter recycled into the low-pressure column again. Conventional types of argon discharge are a transfer of a corresponding fluid into a crude argon column or argon discharge column, from which only an argon-poor, oxygen-rich fluid is recycled into the low-pressure column again.

The advantageous effect of the argon discharge is to be attributed to the fact that the oxygen-argon separation is no longer necessary in the low-pressure column for the discharged argon quantity. The separating-off of the argon from the oxygen in the low-pressure column is itself highly complex and demands a corresponding “heating” power of the main condenser. If argon is discharged and thus the oxygen-argon separation is eliminated, or if said oxygen-argon separation is relocated for example into a crude argon column or argon discharge column, the corresponding argon quantity no longer needs to be separated off in the oxygen section of the low-pressure column, and the heating power of the main condenser can be reduced. Therefore, for an unchanged yield of oxygen, either more air can be injected into the low-pressure column, or more pressurized nitrogen can be extracted from the high-pressure column, which in turn offers advantages in terms of energy.

In a conventional crude argon column, crude argon can be obtained and prepared, in a downstream pure argon column, to form an argon product. By contrast, an argon discharge column serves primarily for argon discharge for the purpose discussed above. An “argon discharge column” may basically be understood to mean a separating column for argon-oxygen separation which serves not for obtaining a pure argon product but for discharging argon from the air to be separated in the high-pressure column and low-pressure column. Its interconnection differs only slightly from that of a conventional crude argon column but it contains far fewer theoretical plates, specifically fewer than 40, in particular between 15 and 30. Similarly to a crude argon column, the bottom region of an argon discharge column is connected to an intermediate point of the low-pressure column, and the argon discharge column is cooled by a top condenser, on the evaporation side of which typically expanded bottoms liquid from the high-pressure column is introduced. An argon discharge column typically has no bottom evaporator.

A major advantage of the present invention consists in that, as will also be discussed below, a known two-column system with high-pressure column and low-pressure column can be utilized more efficiently, that is to say better “exhausted”, than with the use of conventional processes.

For this purpose, an MAC/BAC process is used, with twofold post-boosting of the air (so-called throttle or Joule-Thomson stream) expanded in a Joule-Thomson turbine (also referred to as liquid turbine or dense fluid expander). This twofold post-boosting is performed initially using an impure pressurized nitrogen turbine and subsequently using a so-called medium-pressure turbine, that is to say a turbine which expands air which is subsequently fed into the high-pressure column but which, by contrast to the air expanded in the Joule-Thomson turbine, is cooled only to a considerably lesser extent. Here, the medium-pressure turbine is fed directly from the outlet of the post-compressor (and not from an intermediate extraction point). Here, the advantages of the present invention are realized for example in combination with an argon discharge column (dummy argon column), such as has already been discussed.

Through the use of the impure pressurized nitrogen turbine, the rectification system can be operated with an optimum so-called injection equivalent, whereby energy can be saved. The injection equivalent is normally defined as the sum of the quantity of the nitrogen extracted from the high-pressure column and neither recycled as reflux into the latter nor used as liquid reflux into the low-pressure column and of the quantity of the compressed air expanded into the low-pressure column in relation to the entirety of the compressed air fed into the distillation column system. For example, if an impure pressurized nitrogen turbine is used and, in the latter, a quantity M1 of impure nitrogen is expanded out of the high-pressure column, a quantity M2 of the nitrogen which is extracted from the high-pressure column is extracted as liquid and/or gaseous nitrogen product from the air separation plant (that is to say is not used as reflux into the high-pressure column and/or the low-pressure column), and a quantity M3 of compressed air is supplied to the distillation column system overall, the injection equivalent E is calculated as

E=(M1+M2)/M3 (1)

The increase of the injection equivalent basically permits a reduction in the energy requirement.

The oxygen content in the turbine stream supplied to the impure pressurized nitrogen turbine in this case advantageously approximately corresponds to the oxygen content of a so-called impure nitrogen stream (also referred to as waste gas) from the low-pressure column. In this case, the stated material streams are in equilibrium with one another, and no additional separation work has to be expended (for the purification of the turbine stream to the purity of “pure” pressurized nitrogen with an oxygen content in the ppm range).

In the context of the present invention, the post-boosting of the throttle stream likewise leads to a cost reduction, because in this case, the post-compressor can be reduced by one or two stages and can therefore be produced and operated at lower cost.

The use of two turbines operated at different temperature levels furthermore permits an improved optimization of the Q-T profile in the main heat exchanger, and under some circumstances a design of the medium-pressure turbine with improved efficiency, because the liquid fraction at the turbine outlet is reduced. In this way, too, energy is saved.

The use of a medium-pressure turbine finally permits a relatively great extraction of the pure nitrogen product from the top of the high-pressure column, because the impure nitrogen turbine is hereby relieved of load, and/or relatively high liquid production of liquid nitrogen, liquid oxygen and/or, if a complete argon system is present, liquid argon.

The present invention proposes a process for producing one or more air products by cryogenic separation of air in an air separation plant having a distillation column system which comprises a high-pressure column, which is operated at a first pressure level, and a low-pressure column, wherein a feed air quantity is compressed in a main air compressor to a first pressure level, from which a first fraction and a second fraction are post-compressed in a post-compressor and a third fraction is compressed only to the first pressure level and is fed at the first pressure level into the high-pressure column. This corresponds to the implementation of an MAC-BAC process as discussed above.

In the context of the process according to the invention, the post-compressed first fraction of the feed air quantity is successively compressed further using a first booster and a second booster and is subsequently cooled, expanded to the first pressure level and fed into the high-pressure column. Said fraction is the already mentioned Joule-Thomson stream, wherein, for the expansion of the post-compressed and twofold-boosted first fraction of the feed air quantity, use is made in particular of the above-discussed Joule-Thompson turbine or a combination of turbine and throttle valves.

In the context of the present invention, the post-compressed second fraction of the feed air quantity is cooled and is subsequently expanded, using a first turboexpander which is mechanically coupled to the first or to the second booster, to the first pressure level and fed into the high-pressure column. The first turboexpander is a so-called medium-pressure turbine, which has likewise already been mentioned above.

According to the invention, it is now provided that the first fraction and the second fraction of the feed air quantity are post-compressed in the post-compressor from the first pressure level to a second pressure level at least 3 bar above the first pressure level, and are extracted from the post-compressor jointly at the second pressure level. In other words, the Joule-Thomson stream and the pressurized-air stream supplied to the medium-pressure turbine are extracted jointly from the post-compressor; intermediate extraction of at least these fractions from the post-compressor is not performed. The post-compressed second fraction of the feed air quantity is in this case supplied without a further pressure increase to the first turboexpander; that is to say, by contrast to the post-compressed first fraction of the feed air quantity, no further boosting is performed.

In the context of the present invention, it is furthermore the case that impure nitrogen is extracted from the high-pressure column at the first pressure level and is expanded using a second turboexpander that is to say the already mentioned impure pressurized nitrogen turbine. The second turboexpander is mechanically coupled to the booster taken from the group of the first and second boosters, which is not coupled to the first turboexpander. (If the first turboexpander is coupled to the second booster, the second turboexpander is coupled to the first booster, and vice versa.) With regard to the composition of the “impure” nitrogen, reference is made in particular to the explanations below. Its nitrogen content lies in any case below that of the overhead product of the high-pressure column.

Finally, in the context of the present invention, a fluid enriched with argon is extracted from the low-pressure column, is depleted of argon and is recycled into the low-pressure column. This is performed in particular using an argon discharge column, as has already been mentioned above. An argon discharge from the low-pressure column is thus realized by means of the stated measures. In this way, despite an extraction of liquid and/or pressurized nitrogen from the high-pressure column that is performed according to the invention, the oxygen yield in the low-pressure column can be maintained.

In the context of the present invention, the impure nitrogen extracted from the high-pressure column has an oxygen content of 0.1 to 5 mol percent, in particular of 0.5 to 2 mol percent.

As already discussed, the first turboexpander is in particular fed directly from an outlet of the post-compressor, that is to say the post-compressed second fraction is post-compressed and/or boosted no further. In other words, said second fraction is supplied, in particular without a pressure increase, and thus in particular at the second pressure level, to the first turboexpander. With regard to the corresponding advantages, reference is explicitly made to the above explanations relating to the medium-pressure turbine, which forms the first turboexpander.

In the context of the present invention, the cooling of the first fraction of the feed air quantity after the compression thereof using the first booster and the second booster is performed in particular in the main heat exchanger of the air separation plant, wherein the first fraction of the feed air quantity is cooled in the main heat exchanger to a temperature level of 95 to 110 K, in particular of 97 to 105 K.

The cooling of the second fraction of the feed air quantity before the expansion thereof using the first turboexpander may likewise be performed in the main heat exchanger of the air separation plant, wherein the second fraction of the feed air quantity is extracted from the main heat exchanger at a temperature level of 130 to 200 K, in particular of 150 to 180 K.

In the context of the present invention, the impure nitrogen may, before being expanded in the second turboexpander, be heated in the main heat exchanger of the air separation plant to a temperature level of 110 to 160 K, in particular of 120 to 150 K. As an alternative to this, the impure nitrogen may, before being expanded in the second turboexpander, be heated in a secondary heat exchanger, which is provided in addition to the main heat exchanger of the air separation plant, to a corresponding temperature level.

The argon depletion of the argon-enriched fluid is advantageously performed by means of a distillation column with fewer than 40 theoretical plates, in particular an argon discharge column having the above-specified features. It is however also possible for a conventional crude argon column to be used, in particular in combination with a pure argon column.

In the context of the present invention, the further compression of the post-compressed first fraction of the feed air quantity using the first booster and the second booster is advantageously performed to a third pressure level of 50 to 95 bar, in particular of 60 to 90 bar.

In the context of the present invention, it is advantageously the case that a third fraction of the feed air quantity is cooled to the first pressure level and likewise supplied to the high-pressure column. This is the regular infeed air into the high-pressure column. In the context of the present invention, the first fraction of the feed air quantity may comprise 15 to 40 percent, in particular 20 to 30 percent of the feed air quantity, the second fraction of the feed air quantity may comprise 5 to 30 percent, in particular 10 to 20 percent of the feed air quantity, and/or the third fraction of the feed air quantity may comprise 40 to 70 percent, in particular 45 to 60 percent of the feed air quantity.

Impure nitrogen may likewise be extracted from the low-pressure column and in particular be heated together with the impure nitrogen extracted from the high-pressure column and expanded using the second turboexpander. As mentioned, the impure nitrogen extracted from the low-pressure column and the impure nitrogen extracted from the high-pressure column and expanded using the second turboexpander advantageously have an equal or similar oxygen content.

The invention also encompasses an air separation plant having a distillation column system which comprises a high-pressure column and a low-pressure column, as specified in the corresponding independent patent claim.

The air separation plant according to the invention, which is advantageously configured for carrying out a process as has been discussed above, benefits in the same way from the advantages of the process according to the invention in its discussed embodiments. Reference is therefore explicitly made to the explanations above.

### BRIEF DESCRIPTION OF THE DRAWINGS

FIG. 1 illustrates an air separation plant according to an embodiment of the present invention.

FIG. 2 illustrates an air separation plant according to an embodiment of the present invention.

FIG. 3 illustrates an air separation plant according to an embodiment of the present invention.

FIG. 4 illustrates an air separation plant according to an embodiment of the present invention.

FIG. 5 illustrates an air separation plant according to an embodiment of the present invention.

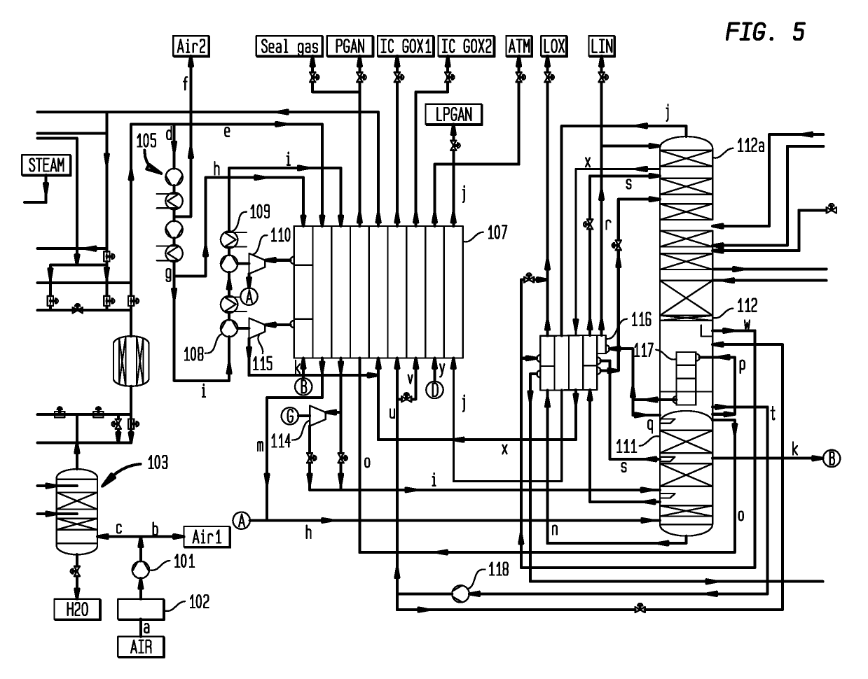

### DETAILED DESCRIPTION OF THE INVENTION

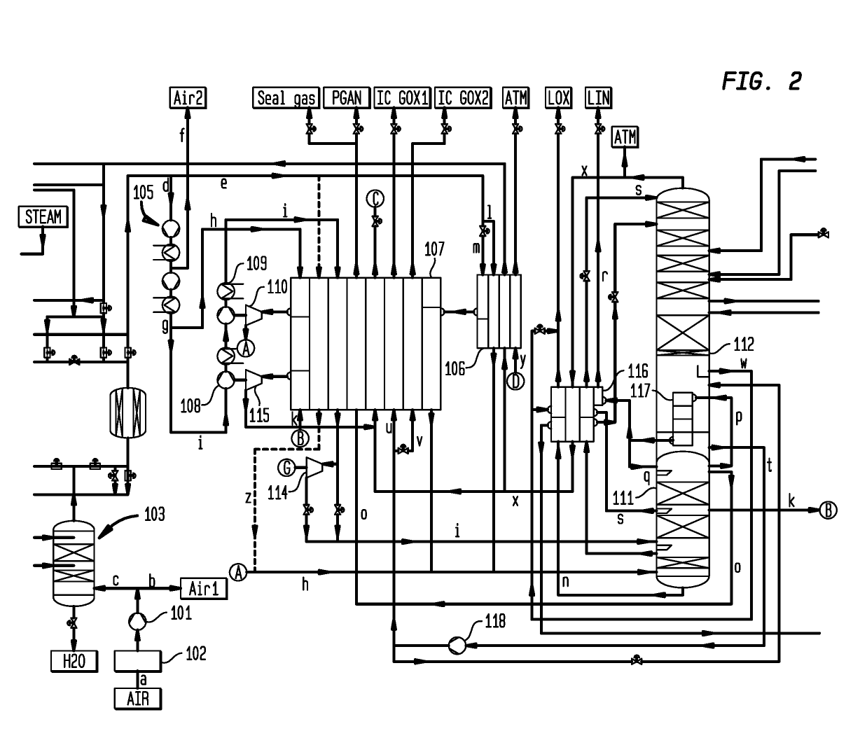

In the figures below, elements which correspond to one another are denoted by identical reference designations. For the sake of clarity, said elements will not be discussed repeatedly. With regard to further details regarding the function of air separation plants and of the respective components thereof, reference is made to the cited technical literature (see for example Haring, FIG. 2.3A and associated explanations).

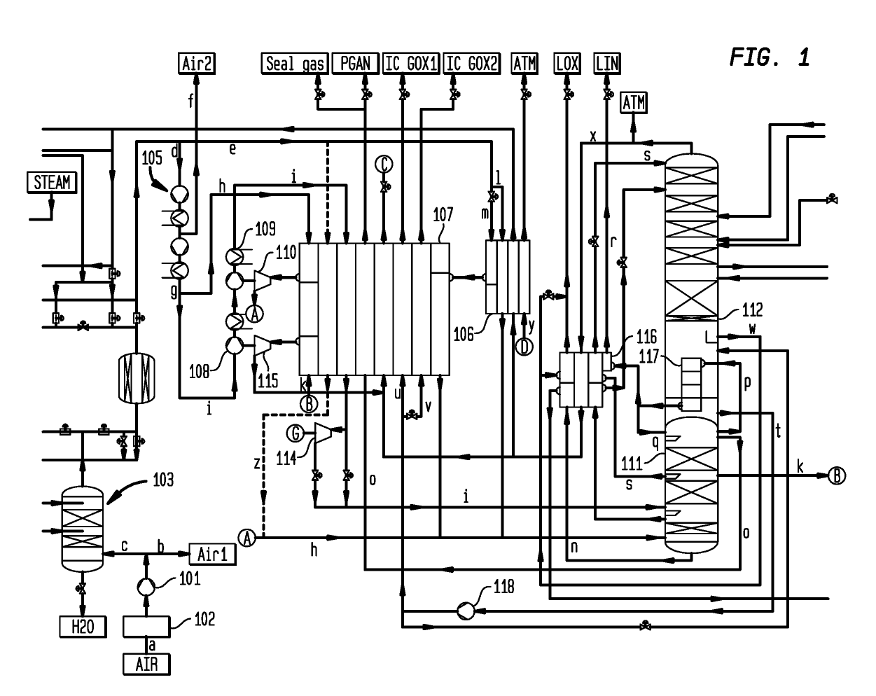

FIG. 1 shows an air separation plant which is configured for operation in accordance with an embodiment of the present invention. The air separation plant is denoted as a whole by 100.

In the air separation plant 100, feed air in the form of a substance stream a (AIR) is, by means of a main air compressor 101, drawn in in a feed air quantity via a filter 102 and compressed to a first pressure level. The feed air of the substance stream c compressed to the first pressure level is partially branched off in the form of a substance stream b (Air1) and is otherwise subjected, in the form of a substance stream c, to further treatment in a manner known per se in a post-cooling unit 103 and an adsorber station 104.

The feed air of the substance stream c compressed to the first pressure level and subjected to the treatment is, at the first pressure level, supplied, in one part, in the form of a substance stream d for post-compression in a post-compressor 105 and, in a further part, in the form of a substance stream e directly for cooling in a secondary heat exchanger 106 and a main heat exchanger 107.

In the illustrated example, the post-compressor 105 comprises two compressor sections and corresponding post-coolers (not separately designated). In the illustrated example, a partial stream of the substance stream d is extracted from the post-compressor 105 in the form of a substance stream f at an intermediate pressure level (Air2), and the rest is compressed in the post-compressor 105 to a second pressure level and exits the post-compressor in the form of a substance stream g.

The substance stream g is divided into a substance stream h and a substance stream i, wherein the substance stream h is supplied at the second pressure level to the main heat exchanger 107, and the substance stream i is subjected to a further pressure increase to a third pressure level in a first booster 108 and a second booster 109, and is supplied at the third pressure level to the main heat exchanger 107.

The substance stream h is extracted from the main heat exchanger 107 at an intermediate temperature level, is expanded to the first pressure level again in a first turboexpander 110, which is mechanically coupled to the second booster 109 in this embodiment, and (see also link A) is fed into a high-pressure column 111 of a distillation column system 10, which furthermore has a low-pressure column 112 and an argon discharge column 113.

The substance stream i is extracted from the main heat exchanger 107 at the cold side, is expanded using a generator turbine 114 or in a throttle valve (without designation) or in both, is thereby at least partially liquefied, and is likewise fed into the high-pressure column 111. The expansion of the substance stream i before the infeed into the high-pressure column 111 is likewise performed to the first pressure level.

Impure nitrogen in the form of a substance stream k with the above-stated exemplary specifications is extracted from the high-pressure column 111 at the first pressure level, is supplied to the main heat exchanger 107 at the cold side (see link B), is extracted from the latter at an intermediate temperature, and is expanded in a second turboexpander 115, which is in turn mechanically coupled to the first booster 108 in this embodiment. The second turboexpander 115 is the impure pressurized nitrogen turbine that has been mentioned multiple times.

In the context of this application, the air of the substance stream i will also be referred to as “first fraction” of the feed air quality (of the substance stream a), the air of the substance stream h will also be referred to as “second fraction” of the feed air quantity, and the air of the substance stream e will also be referred to as “third fraction” of the feed air quantity. As illustrated here, the feed air quantity is compressed in the main air compressor 101 to the first pressure level. The first fraction and the second fraction of the feed air quantity are post-compressed in the post-compressor 105 to the second pressure level and are extracted from the post-compressor 105 jointly at the second pressure level.

The first fraction of the feed air quantity is compressed further using the first booster 108 and the second booster 109 to a third pressure level, is cooled in the main heat exchanger 107, is subsequently expanded to the first pressure level, and is fed into the high-pressure column 111.

The second fraction of the feed air quantity, after cooling in the main heat exchanger 107, is expanded, in the first turboexpander 110 which is mechanically coupled to the second booster 109, to the first pressure level and fed into the high-pressure column 111. Impure nitrogen is extracted at the first pressure level from the high-pressure column and is expanded in the second turboexpander 115, which is mechanically coupled to the first booster 108.

The third fraction of the feed air quantity, that is to say the air of the substance stream e, is supplied to the secondary heat exchanger 106 in the form of two partial streams l and m, wherein the partial stream l is extracted from the secondary heat exchanger 106 at the cold side and the partial stream m is extracted from the secondary heat exchanger 106 at an intermediate temperature. The partial stream m is cooled further in, and extracted at the cold side from, the main heat exchanger 107. Optionally, as illustrated in the form of a substance stream z shown by dashed lines, a partial quantity of the third fraction of the feed air quantity may however also be cooled only in the main heat exchanger 107. The third fraction of the feed air quantity is ultimately likewise fed into the high-pressure column 111.

An oxygen-enriched liquid is drawn off, in the form of a substance stream n, from the bottom of the high-pressure column 111, is conducted through a subcooler 116 and, after use as cooling medium in a top condenser of the argon discharge column 113, is fed into the low-pressure column 112.

Gaseous nitrogen is extracted, in the form of a substance stream o, from the top of the high-pressure column 111, is heated in the main heat exchanger 107, and is made available in the form of one or more pressure products (seal gas, PGAN). Further gaseous nitrogen is drawn off, in the form of a substance stream p, from the top of the high-pressure column 111 and is at least partially liquefied in a main condenser 117 which connects the high-pressure column 111 and the low-pressure column 112 in heat-exchanging fashion. A partial stream q is recycled into the high-pressure column 111, a partial stream r is conducted through the subcooler 116 and is made available as liquid nitrogen product (LIN). In addition to the mentioned substance stream k, impure nitrogen is also drawn off in liquid form, in the form of a substance stream s, from the high-pressure column 111, conducted through the subcooler 116 and fed into the low-pressure column 112.

Oxygen is drawn off, in the form of a substance stream t, from the bottom of the low-pressure column 112, is increased in pressure in the liquid state in a pump 118 (internal compression), is at least partially heated in the main heat exchanger 107 in the form of substance streams u and v and changed into the gaseous or supercritical state, and is output as corresponding pressure products (IC GOX1, IC GOX2). Further oxygen is drawn off, in the form of a substance stream w, from the low-pressure column 112, is partially conducted through the subcooler 116, and is output as liquid product (LOX). The stream w may possibly also be branched off from the substance stream at the pump outlet or from the substance stream v, throttled to a lower pressure, supplied to the subcooler 116 and subsequently output as product.

Impure nitrogen drawn off from the top of the low-pressure column 112 is conducted in the form of a substance stream x through the subcooler 116, is subsequently heated in parts in the secondary heat exchanger 106 and in the main heat exchanger 107, and is finally utilized as desired and in accordance with demand in the post-cooling unit 103 and/or in the adsorber station 104 (in this regard, see also link C).

Fluid drawn off from the top of the argon discharge column 113 (in this regard, see also link D) can be heated in the secondary heat exchanger 106 and released to the atmosphere (ATM). Thus, no argon product is obtained, it rather being the case that argon is merely discharged. As already mentioned above, a corresponding plant may however also be equipped with a conventional argon system, which may comprise in particular a crude argon column and a pure argon column.

Whereas FIG. 1 illustrates an air separation plant 100 in which the substance stream k, that is to say the impure nitrogen from the high-pressure column 111, is fed, after being expanded in the turboexpander 115, to that fraction of the substance stream x which is conducted through the main heat exchanger 107, FIG. 2 illustrates an air separation plant in which the feed to the fraction conducted through the secondary heat exchanger 106 is illustrated.

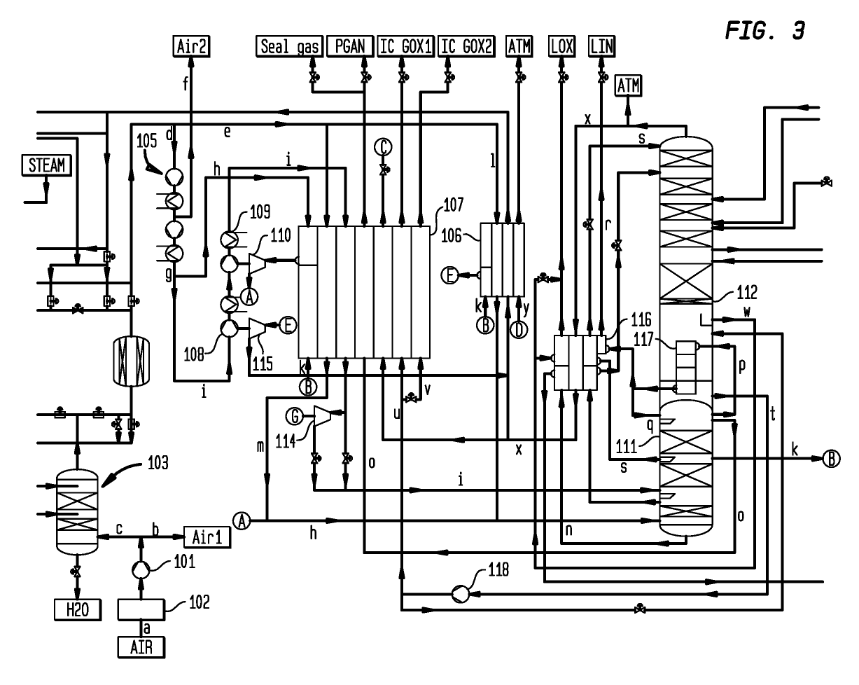

In the air separation plant illustrated in FIG. 3, the substance stream m is conducted not through the secondary heat exchanger 106 but through the main heat exchanger 107 (correspondingly to the substance stream z in FIGS. 1 and 2). In the secondary heat exchanger 106, it is instead the case that the substance stream k (see links B and E) is heated.

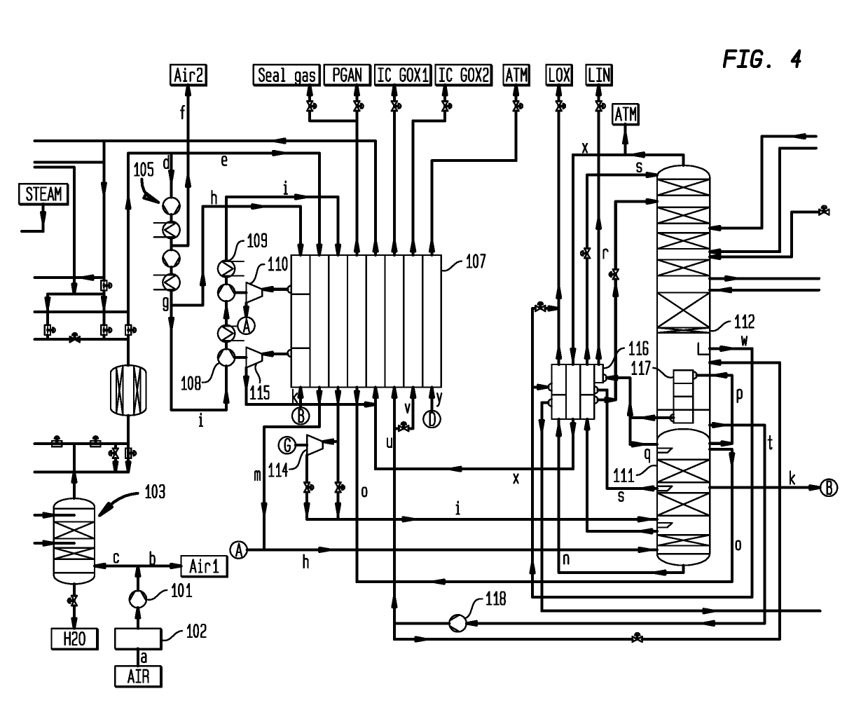

In the air separation plant illustrated in FIG. 4, the secondary heat exchanger 106 is not provided, and the substance stream e is therefore conducted entirely through the main heat exchanger 107. Correspondingly, the substance stream x is heated entirely in the main heat exchanger 107. The substance stream y is also heated in the main heat exchanger 107.

In the air separation plant illustrated in FIG. 4, the low-pressure column 112 has been expanded to include a section 112a for obtaining low-pressure nitrogen. A low-pressure nitrogen stream j can therefore be drawn off from the top of the low-pressure column 112. The low-pressure nitrogen stream j is conducted through the subcooler 116 and is heated in a separate passage of the main heat exchanger 107. A partial stream of the substance stream r can be applied in liquid form to the top of the low-pressure column 112. The embodiment illustrated in FIG. 4 may basically be realized with all of the heat exchanger configurations shown in the preceding figures, that is to say the secondary heat exchanger 106 may be present or absent.

What I claim is:

1. A process for producing one or more air products by cryogenic separation of air in an air separation plant having a distillation column system which comprises a high-pressure column, which is operated at a first pressure level, and a low-pressure column, wherein
a feed air quantity is compressed in a main air compressor to the first pressure level, from which a first fraction and a second fraction are post-compressed in a post-compressor and a third fraction is compressed only to the first pressure level and is fed at the first pressure level into the high-pressure column,
the post-compressed first fraction of the feed air quantity is successively compressed further using a first booster and a second booster is subsequently cooled, expanded to the first pressure level and fed in at least partially liquefied form into the high-pressure column, and
the post-compressed second fraction of the feed air quantity is cooled and is subsequently expanded, using a first turboexpander which is mechanically coupled to the first or to the second booster, to the first pressure level and fed into the high-pressure column,
characterized in that
the first fraction and the second fraction of the feed air quantity are post-compressed in the post-compressor from the first pressure level to a second pressure level at least 3 bar above the first pressure level, and are extracted from the post-compressor jointly at the second pressure level,
impure nitrogen, the nitrogen content of which lies below the overhead product of the high-pressure column, is extracted from the high-pressure column at the first pressure level and is expanded using a second turboexpander, wherein
the second turboexpander is mechanically coupled to the booster taken from the group of the first and second boosters, which is not coupled to the first turboexpander, and
a fluid enriched with argon is extracted from the low-pressure column, is depleted of argon and is recycled into the low-pressure column.

2. The process according to claim 1, in which the impure nitrogen has an oxygen content of 0.5 to 2 mol percent.

3. The process according to claim 1, in which the post-compressed second fraction of the feed air quantity is supplied without a further pressure increase to the first turboexpander.

4. The process according to claim 1, in which the cooling of the first fraction of the feed air quantity after the compression thereof using the first booster and the second booster is performed in the main heat exchanger of the air separation plant, wherein the first fraction of the feed air quantity is extracted from the main heat exchanger at a temperature level of 95 to 110 K.

5. The process according to claim 1, in which the cooling of the second fraction of the feed air quantity before the expansion thereof using the first turboexpander is performed in the main heat exchanger of the air separation plant, wherein the second fraction of the feed air quantity is extracted from the main heat exchanger at a temperature level of 150 to 180 K.

6. The process according to claim 1, in which the impure nitrogen, before being expanded in the second turboexpander, is heated in the main heat exchanger of the air separation plant to a temperature level of 120 to 150 K.

7. The process according to claim 1, in which the impure nitrogen, before being expanded in the second turboexpander, is heated in a secondary heat exchanger, which is provided in addition to the main heat exchanger of the air separation plant, to a temperature level of 120 to 150 K.

8. The process according to claim 1, in which the argon depletion of the argon-enriched fluid is performed by means of a distillation column with fewer than 40 theoretical plates.

9. The process according to claim 1, in which the further compression of the post-compressed first fraction of the feed air quantity using the first booster and the second booster is performed to a third pressure level of 60 to 90 bar.

10. The process according to claim 1, in which the third fraction of the feed air quantity is cooled to the first pressure level and supplied to the high-pressure column.

11. The process according to claim 10, in which the first fraction of the feed air quantity comprises 20 to 30 percent of the feed air quantity, the second fraction of the feed air quantity comprises 10 to 20 percent of the feed air quantity, and the third fraction of the feed air quantity comprises 45 to 60 percent of the feed air quantity.

12. The process according to claim 1, in which impure nitrogen is extracted from the low-pressure column and is heated together with the impure nitrogen extracted from the high-pressure column and expanded using the second turboexpander.

13. The process according to claim 1, in which the first turboexpander is mechanically coupled to the second booster.

14. An air separation plant having a distillation column system which comprises a high-pressure column, which is designed for operation at a first pressure level, and a low-pressure column, wherein the air separation plant has:
a main air compressor which is designed for compressing a feed air quantity to the first pressure level, a post-compressor which is designed for post-compressing a first fraction and a second fraction of the feed air quantity, and means which are designed for compressing a third fraction of the feed air quantity only to the first pressure level and feeding said third fraction into the high-pressure column at the first pressure level,
a first booster and a second booster which are designed for successively further compressing the post-compressed first fraction of the feed air quantity, wherein means are provided which are designed for subsequently cooling the first fraction, expanding said first fraction to the first pressure level and feeding said first fraction in at least partially liquefied form into the high-pressure column, and
means which are designed for cooling the post-compressed second fraction of the feed air quantity, and a first turboexpander which is mechanically coupled to the first or to the second booster and which is designed for subsequently expanding the second fraction of the feed air quantity to the first pressure level and feeding said second fraction into the high-pressure column,
characterized by means which are designed for
post-compressing the first fraction and the second fraction of the feed air quantity in the post-compressor from the first pressure level to a second pressure level at least 3 bar above the first pressure level, and extracting said first fraction and second fraction from the post-compressor jointly at the second pressure level,
extracting impure nitrogen, the nitrogen content of which lies below the overhead product of the high-pressure column, from the high-pressure column at the first pressure level and expanding said impure nitrogen using a second turboexpander, wherein
the second turboexpander is mechanically coupled to the booster taken from the group of the first and second boosters, which is not coupled to the first turboexpander, and
extracting a fluid enriched with argon from the low-pressure column, depleting said fluid of argon and recycling said fluid into the low-pressure column.

15. The air separation plant according to claim 14, which is used for producing one or more air products by cryogenic separation of air in an air separation plant having a distillation column system which comprises a high-pressure column, which is operated at a first pressure level, and a low-pressure column, wherein
a feed air quantity is compressed in a main air compressor to the first pressure level, from which a first fraction and a second fraction are post-compressed in a post-compressor and a third fraction is compressed only to the first pressure level and is fed at the first pressure level into the high-pressure column,
the post-compressed first fraction of the feed air quantity is successively compressed further using a first booster and a second booster is subsequently cooled, expanded to the first pressure level and fed in at least partially liquefied form into the high-pressure column, and
the post-compressed second fraction of the feed air quantity is cooled and is subsequently expanded, using a first turboexpander which is mechanically coupled to the first or to the second booster, to the first pressure level and fed into the high-pressure column,
characterized in that
the first fraction and the second fraction of the feed air quantity are post-compressed in the post-compressor from the first pressure level to a second pressure level at least 3 bar above the first pressure level, and are extracted from the post-compressor jointly at the second pressure level,
impure nitrogen, the nitrogen content of which lies below the overhead product of the high-pressure column, is extracted from the high-pressure column at the first pressure level and is expanded using a second turboexpander, wherein
the second turboexpander is mechanically coupled to the booster taken from the group of the first and second boosters, which is not coupled to the first turboexpander, and
a fluid enriched with argon is extracted from the low-pressure column, is depleted of argon and is recycled into the low-pressure column.
